(19) United States
(12) Patent Application Publication
(10) Pub. No.: US 2019/0052450 A1
(43) Pub. Date: Feb. 14, 2019

(54) Duplex Communication

(71) Applicant: Telefonaktiebolaget LM Ericsson (publ), Stockholm (SE)

(72) Inventors: Gabor FODOR, Hässelby (SE); Magnus FRODIGH, Sollentuna (SE); Muhammad KAZMI, Sundbyberg (SE)

(73) Assignee: Telefonaktiebolaget LM Ericsson (publ), Stockholm (SE)

(21) Appl. No.: 16/077,515

(22) PCT Filed: Feb. 25, 2016
(86) PCT No.: PCT/EP2016/054008

§ 371 Date: Aug. 13, 2018

(51) Int. Cl. H04L 5/16; H04L 5/00; H04W 72/08

(52) U.S. Cl. CPC H04L 5/16; H04W 72/082; H04L 5/0048

(57) ABSTRACT

Data (161) and reference signals (162) are communicated with at least one device (112, 130-1, 130-2) on a radio link according to a first resource mapping (503). Switching, from the first resource mapping (503) to the second resource mapping, is executed and, in response to said switching, data (161) and reference signals (162) are communicated according to the second resource mapping. The first resource mapping (503) implements duplex communication (231, 232) of data (161) and of reference signals (162).

### TECHNICAL FIELD

Various embodiments relate to a method comprising communicating data and reference signals according to a first resource mapping, switching from the first resource mapping to a second resource mapping, and communicating data and reference signals according to the second resource mapping. The first resource mapping and the second resource mapping implement duplex communication of data and of reference signals. Various embodiments relate to a corresponding device.

### BACKGROUND

Recent advances in wireless receiver design make it possible that a device transmits and receives signals using at least partially overlapping frequency resources simultaneously, which is known as full duplex communication, FD. Sometimes, FD is also referred to as in-band FD or true FD. FD enables to efficiently use the available spectrum. However, self-interference at the device performing FD can reduce the reliability of communication.

A further form of duplex communication corresponds to simultaneously transmitting and receiving signals in non-overlapping frequency resources, which is called half duplex communication, HD. Sometimes, HD is also referred to as frequency-division duplex communication.

Recent studies indicate that FD may be able to significantly increase the spectral efficiency, e.g., up to a factor of two if compared to non-duplex communication, see XIE X. and ZHANG X., “Does Full Duplex Double Capacity of Wireless Networks?”, IEEE Infocom Proc. (2014) 253-261. FD is expected to have the potential to increase spectral efficiency in particular in a scenario in which it is possible to tailor self-interference cancellation; self-interference cancellation may be able to reach up to 80 to 90 dB of self-interference cancellation capabilities.

However, duplex communication according to conventional implementations may face certain drawbacks and restrictions. E.g., sometimes it may not be possible or possible only to a limited degree to employ accurate characterization of the quality of communication on the radio link. In this regard, channel sensing may relate to monitoring the channel over the radio link for characterization. E.g., channel sensing may serve the purpose of acquiring channel state information at the receiver and/or the transmitter. Often, channel sensing may be obstructed due to the increased interference experienced in a duplex communication scenario. In such a scenario, tailoring self-interference cancellation can be challenging.

### SUMMARY

Therefore, a need exists for advanced techniques of duplex communication. In particular, a need exists for techniques which may enable to employ accurate channel sensing in case of duplex communication.

This need is met by the features of the independent claims. The dependent claims define further embodiments.

According to an embodiment, a method comprises communicating data and reference signals with at least one device on a radio link according to a first resource mapping. The method further comprises switching from the first resource mapping to a second resource mapping. The method further comprises, in response to said switching: communicating data and reference signals with the at least one device on the radio link according to the second resource mapping. The first resource mapping and the second resource mapping implement duplex communication of data and of reference signals.

According to an embodiment, a method comprises communicating data and reference signals with at least one device on a radio link according to a first resource mapping. The first resource mapping implements FD of data and HD of reference signals.

According to an embodiment, a device comprises a memory. The memory is configured to store instructions executable by at least one processor. The device further comprises the at least one processor. The at least one processor is configured to execute the instructions to perform communicating data and reference signals with at least one further device on a radio link according to a first resource mapping; and switching from the first resource mapping to a second resource mapping; and, in response to said switching, communicating data and reference signals with the at least one further device on the radio link according to the second resource mapping. The first resource mapping and the second resource mapping implement duplex communication of data and of reference signals.

According to an embodiment, a device comprises a memory. The memory is configured to store instructions executable by at least one processor. The device further comprises the at least one processor. The at least one processor is configured to execute the instructions to perform communicating data and reference signals with at least one further device on a radio link according to a first resource mapping. The first resource mapping implements FD of data and HD of reference signals.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a cellular network according to various embodiments.

FIG. 2A schematically illustrates a two-node FD scenario according to various embodiments.

FIG. 2B schematically illustrates a two-node HD scenario according to various embodiments.

FIG. 3A schematically illustrates a two-node FD scenario according to various embodiments, in which device-to-device communication is employed.

FIG. 3B schematically illustrates a two-node HD scenario according to various embodiments, in which device-to-device communication is employed.

FIG. 4A schematically illustrates a three-node FD scenario according to various embodiments.

FIG. 4B schematically illustrates a three-node HD scenario according to various embodiments.

FIG. 5 schematically illustrates a resource mapping implementing FD of data and FD of reference signals for a three-node communication scenario according to various embodiments.

FIG. 6 schematically illustrates a resource mapping implementing FD of data and HD of reference signals for a three-node communication scenario according to various embodiments.

FIG. 7 schematically illustrates a resource mapping implementing FD of data and HD of reference signals for a three-node communication scenario according to various embodiments.

FIG. 8 schematically illustrates a resource mapping implementing HD of data and HD of reference signals for a three-node communication scenario according to various embodiments.

FIG. 9 schematically illustrates a resource mapping implementing FD of data and FD of reference signals in a two-node communication scenario according to various embodiments.

FIG. 10 schematically illustrates a resource mapping implementing FD of data and HD of reference signals in a two-node communication scenario according to various embodiments.

FIG. 11 schematically illustrates a resource mapping implementing FD of data and HD of reference signals in a two-node communication scenario according to various embodiments.

FIG. 12 schematically illustrates a resource mapping implementing HD of data and HD of reference signals in a two-node communication scenario according to various embodiments.

FIG. 13 is a signaling diagram illustrating switching between different resource mappings according to various embodiments.

FIG. 14 is a signaling diagram illustrating switching between different resource mappings according to various embodiments.

FIG. 15 is a flowchart of a method according to various embodiments, wherein FIG. 15 illustrates aspects with respect to executing a threshold comparison of a monitored self-interference level and a plurality of thresholds when determining whether to execute switching between different resource mappings.

FIG. 16 schematically illustrates a further resource mapping implementing HD of reference signals and not implementing communication of data according to various embodiments.

FIG. 17 schematically illustrates switching between different resource mappings according to various embodiments.

FIG. 18 is a flowchart of a method according to various embodiments, wherein FIG. 18 illustrates aspects with respect to executing a threshold comparison of a monitored self-interference level and a plurality of thresholds when determining whether to execute switching between different resource mappings.

FIG. 19 is a signaling diagram illustrating switching between different resource mappings according to various embodiments.

FIG. 20 schematically illustrates selecting a first terminal and a second terminal from a plurality of candidate terminals for implementing a three-node communication scenario according to various embodiments.

FIG. 21 schematically illustrates an access node according to various embodiments.

FIG. 22 schematically illustrates a terminal according to various embodiments.

FIG. 23 schematically illustrates a device according to various embodiments.

FIG. 24 is a flowchart of a method according to various embodiments.

FIG. 25 is a flowchart of a method according to various embodiments.

FIG. 26 is a flowchart of a method according to various embodiments.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of duplex communication, particularly HD and/or FD, are described. Resource mappings defined by time-frequency resources may implement the duplex communication. These techniques of duplex communication may enable to increase a spectral efficiency, also accurate channel sensing and reliable communication of data and reference signals.

In some examples, the techniques of duplex communication are applied to communicating data. Data may comprise application data, sometimes also referred to as payload data or user data, and/or control data.

In further examples, the techniques of duplex communication are applied to communicating reference signals alternatively or additionally to communicating data. The techniques of duplex communication may be applied to various kinds and types of reference signals. In particular, reference signals which enable to implement channel sensing may be subject to the techniques of duplex communication described hereinafter. Sometimes, reference signals are also referred to as pilot signals.

In some examples, the techniques of duplex communication are applied to uplink (UL) communication and/or downlink (DL) communication. E.g., resource mappings described hereinafter may implement UL communication and/or DL communication. E.g., resource mappings as described hereinafter may comprise transitions between UL communication and DL communication, e.g., between adjacent transmission time intervals (TTIs). Different duplex schemes may be employed for UL and DL communication, respectively. It is also possible to employ the same duplex scheme for, both, UL and DL communication.

In some examples, the techniques of duplex communication are applied at an access node terminating a radio link of a cellular network. Alternatively or additionally, the techniques of duplex communication are applied at a terminal communicating with the access node via the radio link. The terminal may be attachable to the cellular network. The terminal may be embodied as a device selected from the group comprising: a cell phone; a smart phone; laptop; a Machine Type Communication (MTC) device; a smart television; a computer; a tablet, a laptop-embedded equipment; a laptop-mounted equipment; a Universal Serial Bus dongle; an machine-to-machine device; a Personal Digital Assistant (PDA); a wireless modem; etc.

In some examples, the techniques of duplex communication are applied to a two-node communication scenario. The two-node communication scenario may implement duplex communication between two devices such as the access node and the terminal or between two terminals, sometimes referred to as device-2-device communication, D2D. Alternatively or additionally, the techniques of duplex communication may be applied to three-node communication scenarios. In three-node communication scenarios, FD is implemented at the access node, and two terminals communicate with the access node. Each of the two terminal implements non-duplex communication, i.e., is not transmitting and receiving simultaneously. In a three-node communication scenario, it is typically not required that the terminals are FD or HD capable.

In some examples, the techniques of duplex communication comprise dynamic adjustment of the applied duplex scheme. Here, the techniques may comprise switching between different resource mappings. E.g., data and reference signals may be communicated on a radio link according to a first resource mapping; then, switching from the first resource mapping to the second resource mapping may be executed. In response to said switching, data and reference signals may be communicated on the radio link according to a second resource mapping. The first resource mapping and the second resource mapping may implement duplex communication of data and of reference signals. By such techniques, it is possible to dynamically adjust the duplex scheme to properties of the radio link. More or fewer resources may be reserved for communication of reference signals. Thereby, it may be possible to balance spectral efficiency and reliable communication of data.

In some examples, mixed duplex schemes may be applied where data and reference signals are communicated different duplex strategies.

E.g., data and reference signals may be communicated on a radio link according to a first resource mapping. The first resource mapping may implement FD of data and HD of reference signals. By implementing FD of data, a high spectral efficiency can be achieved; on the other hand, by implementing HD of reference signals, reliable and accurate channel sensing can be achieved.

In some examples, channel sensing may comprise acquiring radio measurements. The radio measurements may characterize the quality of communicating on the radio link. The techniques described herein may allow for acquiring high-quality radio measurements. Such strategies for acquiring radio measurements can rely on particular resource mappings for communicating reference signals based on which the radio measurements are determined. In this context, corresponding measurement reports may comprise channel state information (CSI). Strategies for acquiring radio measurements as described herein may be applied at a receiver-side with corresponding radio measurements comprising Channel State Information Receiver (CSIR) and/or, may be applied at a transmitter-side with corresponding radio measurements comprising Channel State Information Transmitter (CSIT). E.g., in a FD scenario, due to channel reciprocity, CSIR may equal CSIT. In particular, the techniques described herein may enable to acquire high-quality radio measurements where self-interference due to duplex communication is limited. Furthermore, the techniques described herein may enable to acquire high-quality radio measurements with overhead of resource allocation for reference signals is corresponding being limited.

In some examples, as part of the channel sensing, performance characteristics of communicating on the radio link are continuously monitored. An example is the interference level. Here, the techniques may make use of continuously communicated UL reference signals and DL reference signals. E.g., self-interference at the access node may be continuously estimated using feedback from one or more terminals and/or channel sensing performed locally at the access node.

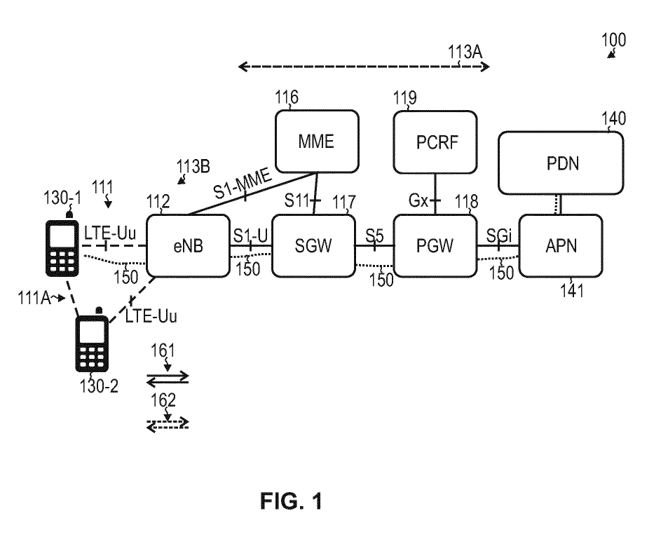

FIG. 1 schematically illustrates an architecture of a cellular network 100 which may be used for implementing the concepts as outlined above. FIG. 1 is an example disclosed in the context of the Third Generation Partnership (3GPP) Long Term Evolution (LTE) for illustrative purposes only. Similar techniques as disclosed herein can be readily applied to various kinds of 3GPP-specified networks, such as Global Systems for Mobile Communications (GSM), Wideband Code Division Multiplex (WCDMA), General Packet Radio Service (GPRS), Enhanced Data Rates for GSM Evolution (EDGE), Enhanced GPRS (EGPRS), Universal Mobile Telecommunications System (UMTS), and High Speed Packet Access (HSPA). Similar techniques may be applied to 3GPP 5G technology. However, operation of the network is not limited to the scenario of a cellular network or a 3GPP-specified network. E.g., at least parts of the radio link(s) of the wireless network could be operated according to the Wireless Local Area Network (WLAN or Wi-Fi) radio access technology (RAT), Bluetooth, Near Field Communication, or satellite communication.

Depending on the particular type of communication protocol, the access node may be embodied as and/or may include, respectively: a base station such as an evolved NodeB (eNodeB, eNB) or NodeB; access point; wireless access point; relay; base transceiver station; transmission point (particularly in a coordinated multipoint, CoMP, scenario); transmission node; remote radio unit (RRU); remote radio head (RRH); one of nodes in distributed antenna systems (DAS) which, e.g., may be formed by an eNB and one or more RRUs/RRHs; radio network controller (RNC); base station controller (BSC); etc. Nodes in a distributed antenna system (DAS) may be employed in dynamic point switching in which a terminal is served by multiple nodes, e.g., an eNB and one or more remote radio heads. DAS may be employed, e.g., in any FD scenario between a particular DAS node and the terminal.

In FIG. 1, two terminals 130-1, 130-2 are connected via E-UTRA RAT 113B to an access node in the form of an eNB 112. The eNB 112 and the terminals 130-1, 130-2 communicate using packetized traffic via a radio link 111. Various channels may be implemented on the radio link 111 for utilizing communication of data via the radio link 111. Such channels may include logical channels. The channels may be associated with dedicated time-frequency resources on the radio link 111. The channels may include a Physical DL Control Channel (PDCCH) corresponding to a DL control channel, a Physical UL Control Channel (PUCCH) corresponding to an UL control channel, a Physical DL Shared Channel (PDSCH) corresponding to a DL payload channel, and a Physical UL Shared Channel (PUSCH) corresponding to a UL payload channel. The channels may also include a Physical Hybrid Automatic Repeat Request Indicator Channel (PHICH) usable for re-transmission control of payload data.

In FIG. 1, the terminal 130-1 is connected to a packet data network (PDN) 140 via a bearer 150 (illustrated by the dotted line in FIG. 1) and to an access point node 141. The PDN 140 may offer a service such Voice over LTE (VoLTE) to the terminal 130. The PDN 140 may implement an IP Multimedia Subsystem (IMS) or may be connected to the Internet. E.g., the bearer 150 may be implemented by a plurality of interconnecting sub-bearers and/or secure tunnels facilitating communication of data. E.g., the bearer 150 may be identified by an Internet Protocol (IP) address of the terminal 130-1. E.g., the bearer 150 may be identified by a bearer identification (bearer ID). The bearer 150 is typically associated with a certain quality of service (QoS) requirement. E.g., the QoS requirement may be specified by a QoS class identifier (QCI) associated with the bearer 150. The QoS requirement, in particular, may relate to latency. E.g., the latency may be specified in-between certain layers of the protocol stack between two nodes of the cellular network 100. E.g., the latency may correspond to a delay between requesting data associated with the service and receiving the requested data. The techniques disclosed herein help to meet such QoS requirements.

The bearer 150 may be usable for communication of data 161 (indicated by full arrows throughout the Figures) such as payload data and/or control data. The payload data may relate to data used by higher layers of a protocol stack, e.g., an application layer. The payload data may be user-specific for a subscriber associated with the terminal 130-1 connectable to the cellular network 100 and/or the bearer 150. Further, reference signals 162 (indicated by dashed arrows throughout the Figures) are communicated between each one of the terminals 130-1, 130-2 and the eNB 112. Based on reference signals 162, channel sensing may be performed. Channel sensing may enable to determine CSI for, both, a transmitter and receiver implemented by the eNB 112 and the terminals 130-1, 130-2, respectively. Examples of transceiver functionalities that may require CSI may include: adaptive channel coding; multi-antenna pre-coding for beamforming and/or spatial multiplexing; data symbol detection and decoding; adaptive rank adaptation; cell identification; signal strength assessment; signal quality assessment; positioning measurements; time synchronization; frequency synchronization; characterization of the radio link 111 including, e.g., Doppler speed, channel coherence bandwidth, multipath delay spread, etc. Such transceiver functionalities may benefit from a more accurate CSI which may be determined based on the techniques disclosed herein.

Reference signals 162 may carry predefined symbol sequences, sometimes referred to as reference symbols sequences. Reference signals may facilitate acquiring CSI during data communication in a connected state, i.e., while the bearer 150 is established, and/or before actual data communication, e.g., before or during the process of establishing the bearer 150.

Examples of reference signals 162 may include: the Demodulation Reference Signal (DMRS); the Sounding Reference Signal (SRS) communicated in UL direction; the terminal-specific reference signal communicated in DL direction; the cell-specific reference signals (CRS) communicated in DL direction such as the CSI-RS; and the Discovery Reference Signal (DRS). See, e.g.: 3GPP, TS 36.211 v10.1.0, Physical Channels and Modulation, March 2011; and 3GPP, TS 36.213 v10.1.0, Physical Layer Procedures, March 2011.

Typically, a trade-off between communicating data 161 and reference signals 162 is employed in the communication over the radio link 111. Allocating more resources to communicating reference signals 162 may typically provide a more accurate channel sensing, thus increasing a likelihood of successful communication of data 161. On the other hand, fewer resources may be available for communicating data 161. Thus, an effective data rate available for communicating payload data on the bearer 150 may be characterized by an optimum allocation of resources for communication of data 161 and reference signals 162. The techniques described herein may help to operate the communication on the radio link 111 at or close to this optimum.

FIG. 1 further schematically illustrates the evolved packet system (EPS) architecture of the LTE RAT. The EPS comprises an evolved packet core (EPC) as a core network 113A and the E-UTRA 113B.

The reference point—typically also called “interface”—implemented by the radio link 111 between the terminals 130-1, 130-2 and the eNB 112 operates according to the LTE-uU protocol. The bearer 150 may pass along the radio link 111.

The eNB 112 is connected to a Serving Gateway (SGW) 117 implementing a gateway between the radio access network and the core network. As such, the SGW 117 may route and forward data and may act as a mobility anchor of the user plane during handovers of the terminals 130-1, 130-2 between different cells of the cellular network 100. The reference point between the eNB 112 and the SGW 117 operates according to the S1-U protocol.

The SGW 117 is connected via a reference point operating according to the S5 protocol to a further gateway node implemented by, e.g., a Packet Data Network Gateway (PGW) 118. The PGW 118 serves as a point of exit and point of entry of the cellular network 100 for data packets of the bearer 150 towards the PDN 140. As such, the PGW is connected with the access point node 141 of the PDN 140 via a reference point operating according to the SGi protocol.

Access functionalities of the terminals 130-1, 130-2 to the PDN 140, e.g., access functionality to the bearer 150, may be controlled by a control node implemented by a Mobility Management Entity (MME) 116. The MME 116 is connected via a reference point operating according to the S1-MME protocol with the eNB 112. Further, the MME 116 is connected via a reference point operating according to the S11 protocol with the SGW 117. E.g., the MME 116 may check whether the subscriber associated with the terminal 130 is authorized to establish the bearer 150 by accessing the access point node 141.

Policy and charging functionality of the bearer 150 is controlled by a control node 119 implemented for example by a Policy and Charging Rules Function (PCRF) 119. The PCRF 119 is connected via a reference point operating according to the Gx protocol with the PGW 118. The PGW 118 may implement a Policy and Charging Policy and Charging Enforcement Function (PCEF) which is controlled by Policy and Charging Control (PCC) rules provided by the PCRF 119 via the Gx protocol.

A further radio link 111A may be established between the two terminals 130-1, 130-2. D2D communication is facilitated by the further radio link 111A. Sometimes, D2D communication may include Proximity Services (ProSes).

In a non-duplex communication scenario, the devices 112, 130-1, 130-2 either transmit or receive at a given point in time. However, at least some of the devices 112, 130-1, 130-2 may be configured to implement duplex communication, e.g., FD and/or HD. Then, different duplex schemes as outlined below can be applied.

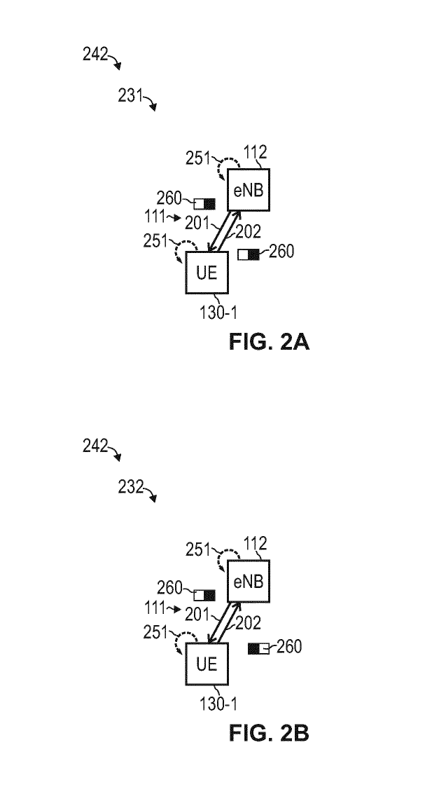

FIG. 2A illustrates aspects with respect to FD 231 in a two-node communication scenario 242. As illustrated in FIG. 2A, both the eNB 112 as well as the terminal 130-1 transmit and receive data 161 at the same point in time. For this, the same resources 260 are used for UL 202 and DL 201. Because the same resources 260 are used, self-interference 251 is present at, both the eNB 112 as well as the terminal 130-1. A scenario according to FIG. 2A is sometimes also referred to as bidirectional FD. Such a scenario allows to implement a high spectral efficiency.

FIG. 2B illustrates aspects with respect to HD 232 in a two-node communication scenario 242. FIG. 2B generally corresponds to FIG. 2A; however, UL 202 and DL 201 employ different resources 260; the resources are separated from one another in a frequency domain. While self-interference 251 may also occur in the HD 232, self-interference 251 may be weaker if compared to the FD 231 scenario of FIG. 2A. Thus, while the spectral efficiency may be degraded for HD 232 if compared to FD 231, transmission reliability may be increased for the HD 232 if compared to the FD 231.

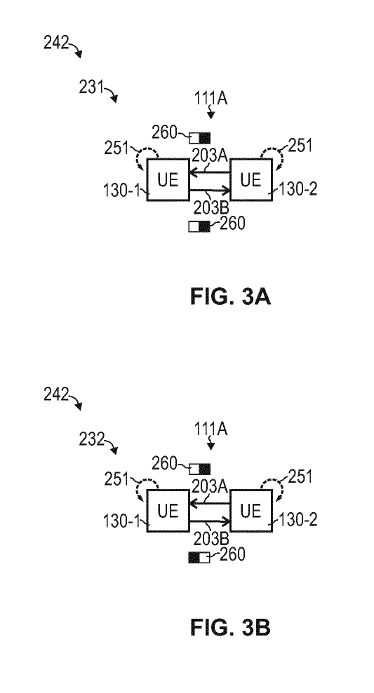

FIG. 3A illustrates aspects with respect to FD 231 in a two-node communication scenario 242. FIG. 3A generally corresponds to FIG. 2A, but D2D communication is implemented on the further radio link 111A. Two directions of communication 203A, 203B are implemented. CSIT and CSIR are typically equal in such a scenario due to channel reciprocity. Such a scenario allows to implement a high spectral efficiency.

FIG. 3B illustrates aspects with respect to HD 232 in a two-node communication scenario 242. FIG. 3B generally corresponds to FIG. 2B, but D2D communication is implemented on the further radio link 111A. Two directions of communication 203A, 203B are implemented. CSIT and CSIR are typically equal in such a scenario due to channel reciprocity. While self-interference 251 may also occur in the HD 232, self-interference 251 may be weaker if compared to the FD 231 scenario of FIG. 3A. Thus, while the spectral efficiency may be degraded for HD 232 if compared to FD 231, transmission reliability may be increased for the HD 232 if compared to the FD 231.

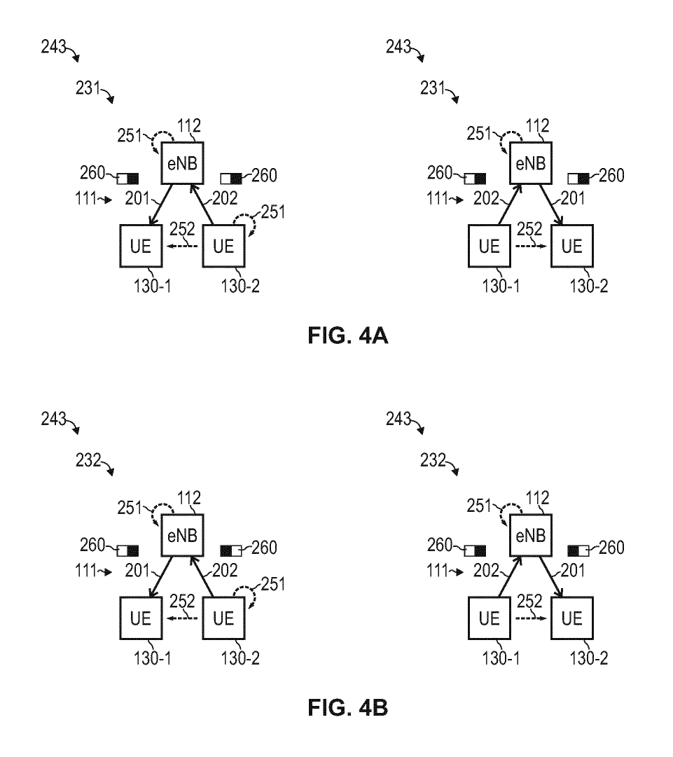

FIG. 4A illustrates aspects with respect to FD 231 in a three-node communication scenario 243. In FIG. 4A, two scenarios are illustrated: in a left part of FIG. 4A, DL communication 201 for the terminal 130-1 and UL communication 202 for the terminal 130-2; in a right part of FIG. 4A, UL communication 202 for the terminal 130-1 and DL communication 201 for the terminal 130-2. For UL and DL communication 201, 202, the same time-frequency resources 260 are employed. Therefore, self-interference 251 and cross-interference 252 between the terminals 130-1, 130-2 as illustrated by dashed arrows occurs.

FIG. 4B illustrates aspects with respect to HD 232 in a three-node communication scenario 243. FIG. 4B generally corresponds to FIG. 4A; however, UL 202 and DL 201 employ different resources 260. While self-interference 251 and cross-interference 252 may also occur for HD 232, they may be suppressed if compared to the FD 231.

As can be seen from FIGS. 4A and 4B, each one of the terminals 130-1, 130-2 either transmits or receives at a given point in time. Thus, it is not required that the terminals 130-1, 130-2 are duplex capable. In the scenarios of FIGS. 2A, 2B, 3A, 3B, 4A, and 4B, the eNB 112 is required to transmit and receive at the same point in time. In other scenarios, HD may also be implemented for the eNB 112, wherein the eNB 112 either transmits or receives at a given point in time (not shown in the FIGs.)

While the various aspects with respect to duplex communication 231, 232 have been illustrated in FIGS. 2A, 2B, 3A, 3B, 4A, and 4B with respect to data 161, respective techniques may be readily employed for reference signals 162.

From the above, it is apparent that a wide variety of duplex schemes exist. The various examples described herein may be applied for any duplex scheme including as outlined above in FIGS. 2A, 2B, 3A, 3B, 4A, and 4B.

In FIGS. 2A, 2B, 3A, 3B, 4A, and 4B, the resources 260 have been schematically illustrated. Different resources 260 may be defined by different sub-carriers and by different time instances, and may encode orthogonal frequency division multiplex (OFDM) symbols. A resource may be embodied as a resource element. It is also possible to implement the different 260 resources using different resource blocks; each resource block may comprise a plurality of resource elements in time and frequency, e.g., 84 resource elements. It is also possible to implement different resources 260 using different carriers, each carrier comprising a plurality of sub-carriers. It is also possible to implement different resources 260 using different frequency channels or frequency layers, etc. The particular time-frequency allocation of the different resources 260 defines a resource mapping. Hence, the resource mapping may be defined on resource element or resource block granularity.

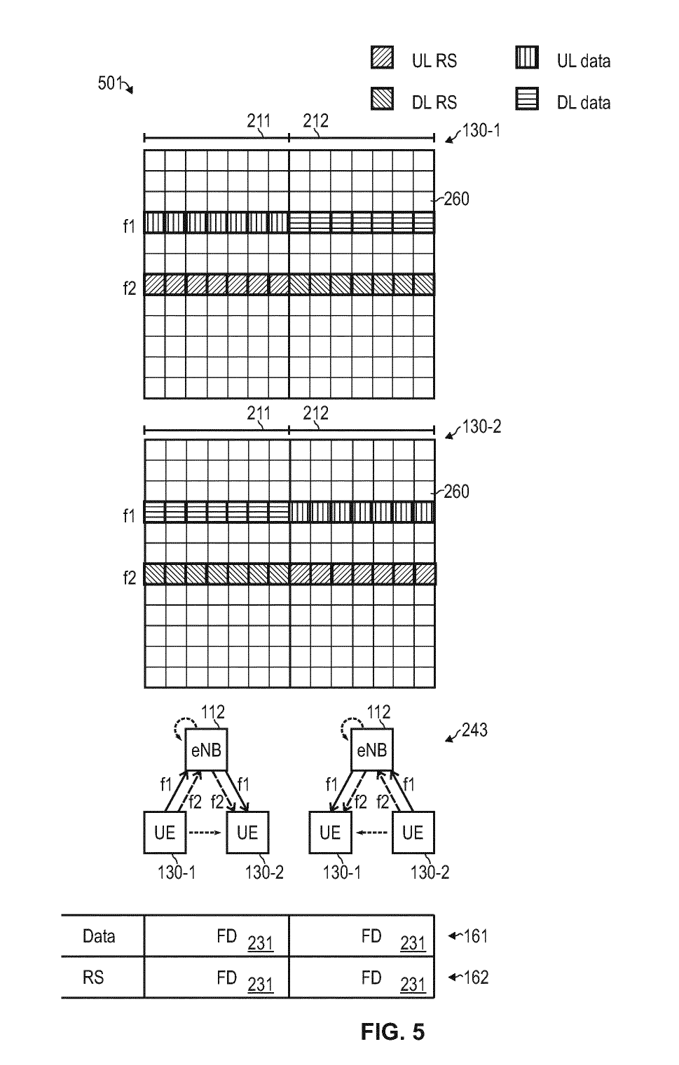

FIG. 5 illustrates aspects with respect to a resource mapping 501 employing FD 231 for both communication of data 161 as well as communication of reference signals 162. FIG. 5 corresponds to a three-node communication scenario 243. The set of resources 260 allocated for communication of data 260 may be associated with a channel, e.g., a data channel or a control channel. The time-frequency resource allocation is illustrated in FIG. 5 for the terminal 130-1 (upper part of FIG. 5) and for the terminal 130-2 (lower part of FIG. 5). At a given point in time, either UL or DL communication takes place between the eNB 112 and each one of the terminals 130-1, 130-2.

In FIG. 5, the illustrated resource mapping 501 comprises different allocations for a first timeslot 211 and a second time slot 212. E.g., in the 3GPP LTE framework, the timeslots 211, 212 may correspond to a subframe. Sometimes, the timeslots 211, 212 may also be referred to as TTIs. The timeslots 211, 212 may comprise one or more OFDM symbols per frequency.

In the first timeslot 211, UL communication 202 takes place between the eNB 112 and the terminal 130-1, while DL communication 201 takes place between the eNB 112 and the terminal 130-2. The same frequency f1 is employed for the UL communication 202 of data 161 and the DL communication 201 of data 161 between the eNB and the terminals 130-1, 130-2, respectively. The same frequency f2 is employed for the UL communication 202 of reference signals 162 and the DL communication 201 of reference signals 162 between the eNB 112 and the terminals 130-1, 130-2, respectively.

In the second timeslot 212, DL communication 201 takes place between the eNB 112 and the terminal 130-1; while UL communication 202 takes place between the eNB 112 and the terminal 130-2. Again, the same frequency f1 is employed for the UL communication 202 of data 161 and the DL communication 201 of data 161 between the eNB and the terminals 130-1, 130-2, respectively. Further, the same frequency f2 is employed for the UL communication 202 of reference signals 162 and the DL communication 201 of reference signals 162 between the eNB 112 and the terminals 130-1, 130-2, respectively.

The resource mapping 501 in FIG. 5 allows for a high spectral efficiency. At the same time, interference 251, 252 affects communication of, both data 161 as well as of reference signals 162. However, because communication of reference signals 162 is separated in the frequency domain from communication of data 161, interference negatively affecting reference signals 162 is limited. Adequate radio operations such as high-quality radio measurements for channel sensing comprising, e.g., CSI acquisition, channel estimation, etc., may be performed.

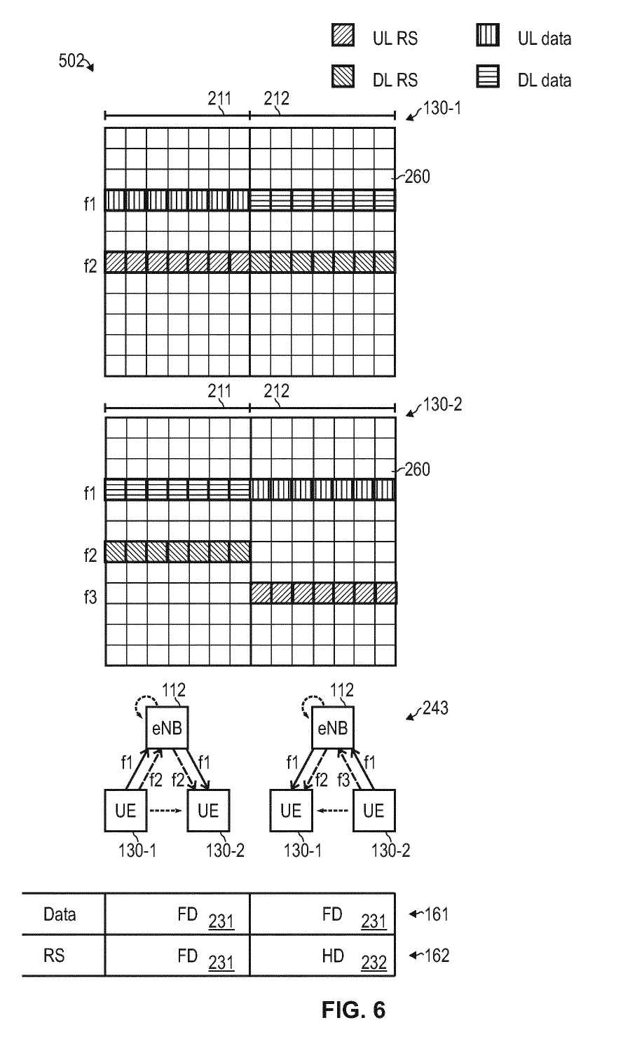

FIG. 6 illustrates in a three-node communication scenario 243 aspects with respect to a resource mapping 502 employing FD 231 of data 161. The resource mapping 502 employs both FD as well as HD 232 of reference signals 162.

The resource mapping 502 employs FD 231 of reference signals 162 in the first timeslot 211 and employs HD 232 of reference signals 162 in the second timeslot 212. I.e., the resource mapping 502 employs FD 231 of UL reference signals 162 communicated between the eNB 112 and the terminal 130-1 and DL reference signals 162 communicated between the eNB 112 and the terminal 130-2. The resource mapping 502, on the other hand, employs HD of DL reference signals 162 communicated between the eNB 112 and the terminal 130-1 and UL reference signals 162 communicated between the terminal 130-2 and the eNB 112.

The duplex scheme 231, 232 may be flexibly adjusted for UL and DL reference signals 162 in the various examples described herein. In other examples, the resource mapping may employ FD 231 of DL reference signals 162 communicated between the eNB 112 and the terminal 130-1 and UL reference signals 162 communicated between the eNB 112 and the terminal 130-2. The resource mapping, on the other hand, may employ HD of UL reference signals 162 communicated between the eNB 112 and the terminal 130-1 and DL reference signals 162 communicated between the terminal 130-2 and the eNB 112.

Similar considerations also apply to the communication of data 161. E.g., in some examples, the resource mapping may employ FD 231 of DL data 161 communicated between the eNB 112 and the terminal 130-1 and of UL data 161 communicated between the eNB 112 and the terminal 130-2. The resource mapping, on the other hand, may employ HD of UL data 161 communicated between the eNB 112 and the terminal 130-1 and DL data 161 communicated between the terminal 130-2 and the eNB 112. E.g., in some examples, the resource mapping may employ FD 231 of UL data 161 communicated between the eNB 112 and the terminal 130-1 and DL data 161 communicated between the eNB 112 and the terminal 130-2. The resource mapping, on the other hand, may employ HD of DL data 161 communicated between the eNB 112 and the terminal 130-1 and UL data 161 communicated between the terminal 130-2 and the eNB 112.

In the example of FIG. 6, a transition between UL communication 202 and DL communication 201 takes place at the boundaries of the timeslots 211, 212. The particular point in time of such a transition is not decisive for the functioning of the techniques disclosed herein. Thus, in the various examples described, transitioning between UL and DL communication 201, 202 may also take place at intermediate positions of a timeslot 211, 212. The illustrated resource mapping allows to efficiently allocate the spectrum for communication of data 161, while, at the same time, interference 251, 252 is at least partially limited for communication of reference signals 162 by using the HD 232. In particular, self-interference 251 as well as terminal-2-terminal interference 252 is eliminated from communication of reference signals 162 in the second timeslot 212. This, in turn, typically improves the quality of radio operations, such as acquired CSI, channel estimation or channel sensing.

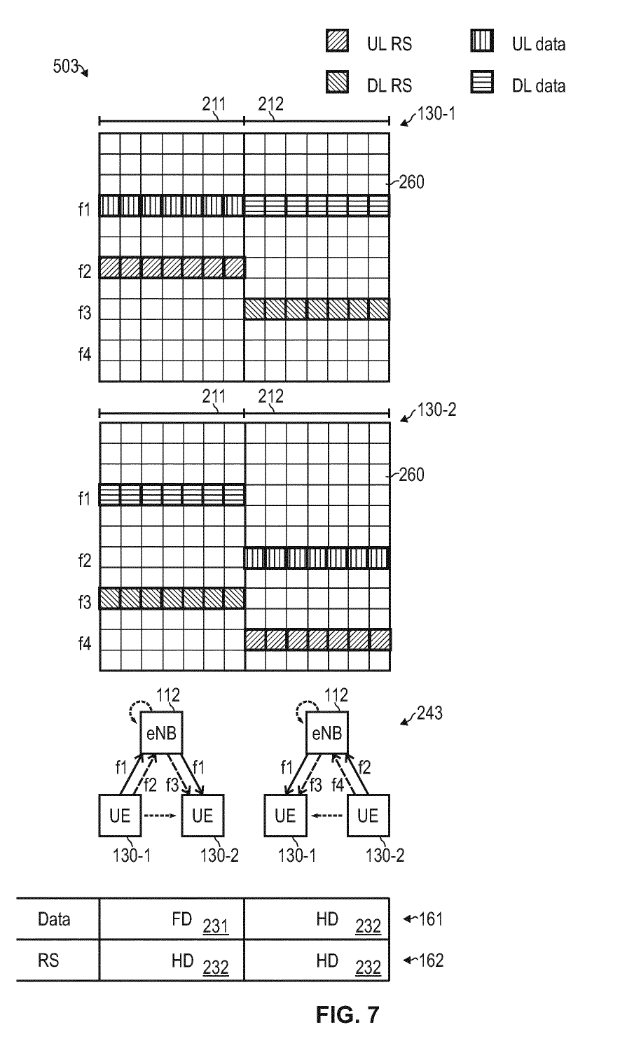

FIG. 7 illustrates in a three-node communication scenario 243 aspects with respect to a resource mapping 503 employing both FD 231 of data 161 as well as HD 232 of data 161. The resource mapping 503 further employs HD 232 of reference signals 162. This resource mapping 503 reduces spectrum allocation efficiency if compared to the examples of FIGS. 5 and 6. On the other hand, the interference 251, 252 is limited by using the HD 232 extensively. Typically, according to the illustrated resource mapping 503, high-quality radio operations such as the acquisition of high-quality channel sensing, robust channel estimation, high-accuracy radio measurements, etc. during both timeslots 211, 212 is possible. This is accompanied by the expense of some extra resources 260 for communication of reference signals 162 if compared to a scenario of FIG. 5 or 6.

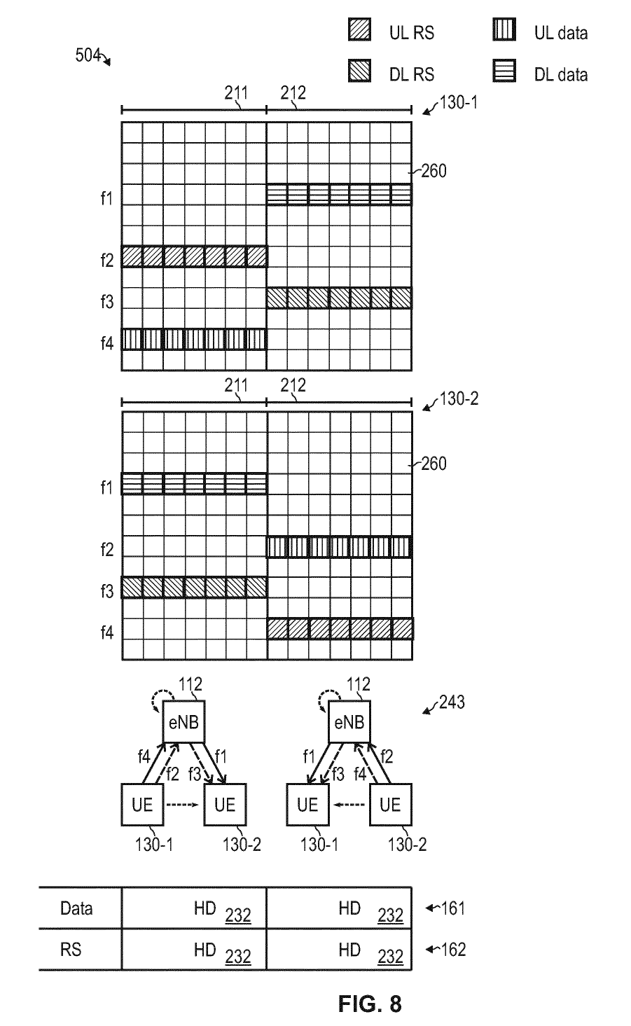

FIG. 8 illustrates in a three-node communication scenario 243 aspects with respect to a resource mapping 504 employing HD 232 of data 161 as well as HD 232 of reference signals 162. This resource mapping 504 limits the interference 251, 252 by using the HD 232 for both communication of data 161 as well as communication of reference signals 162.

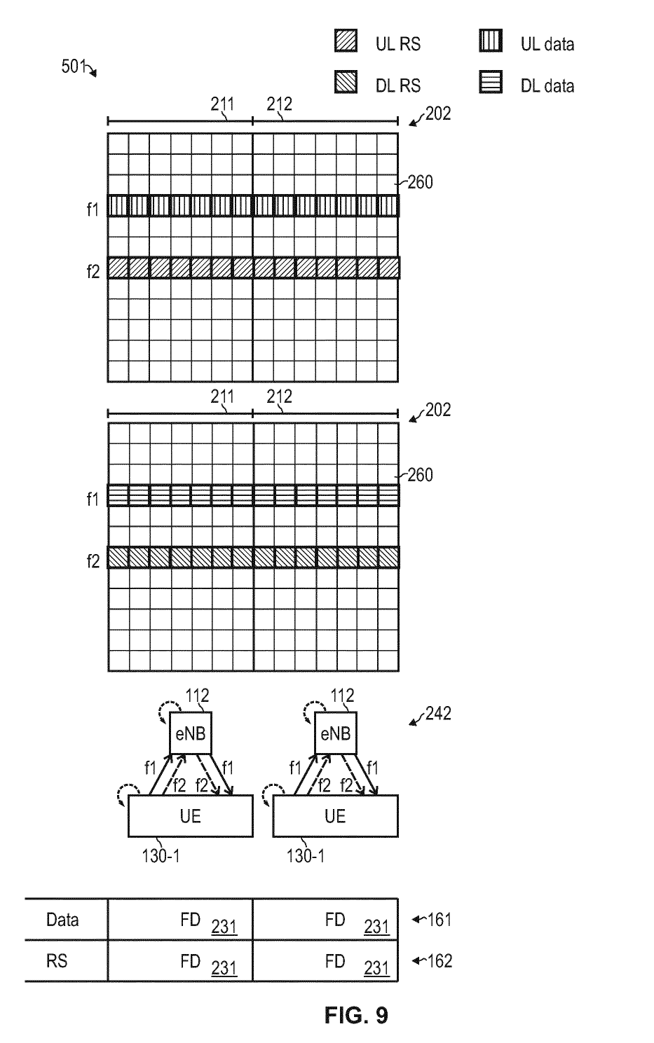

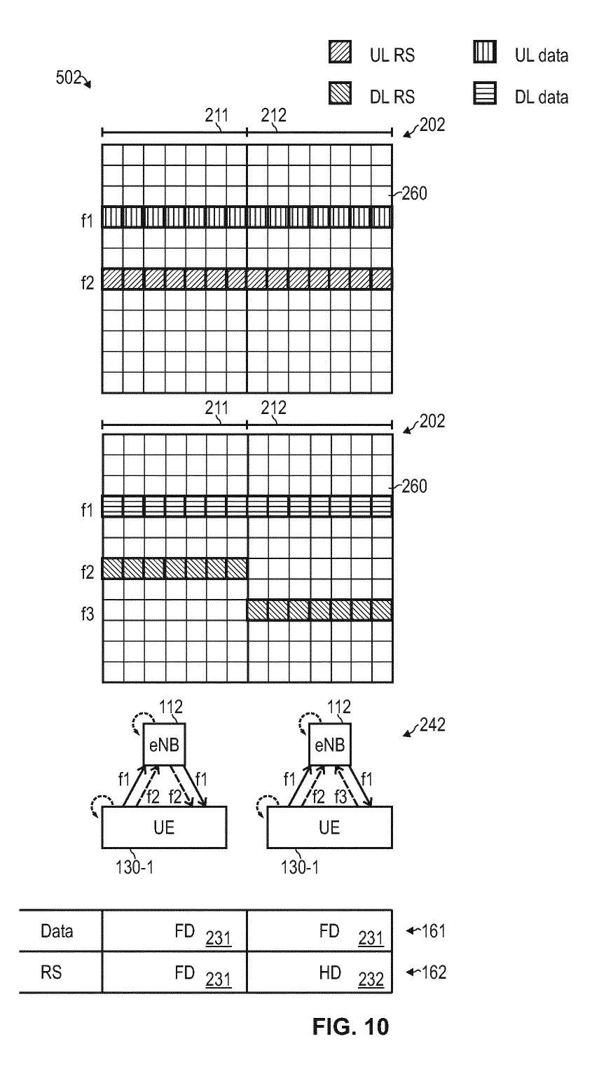

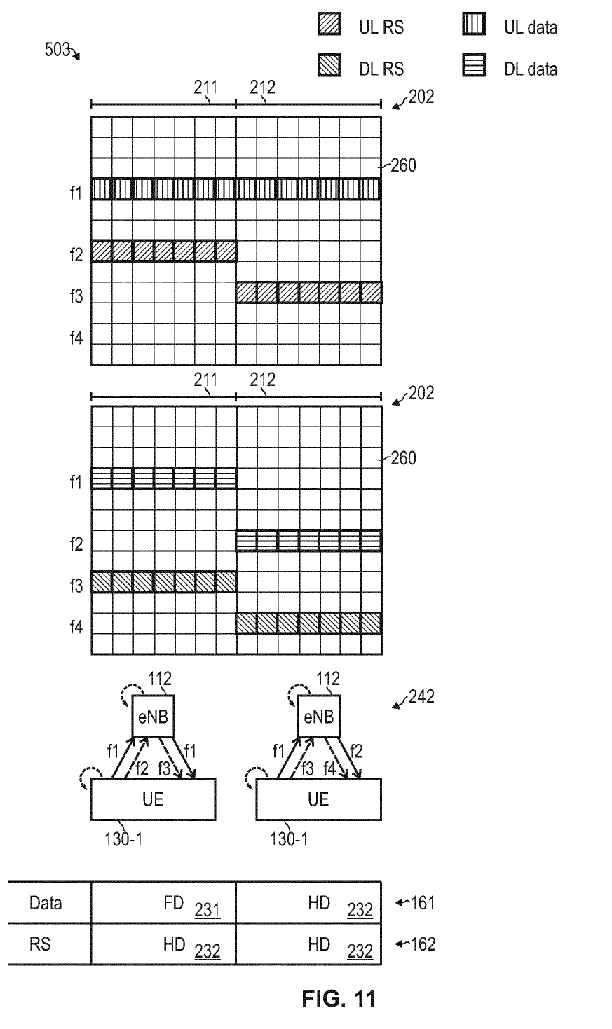

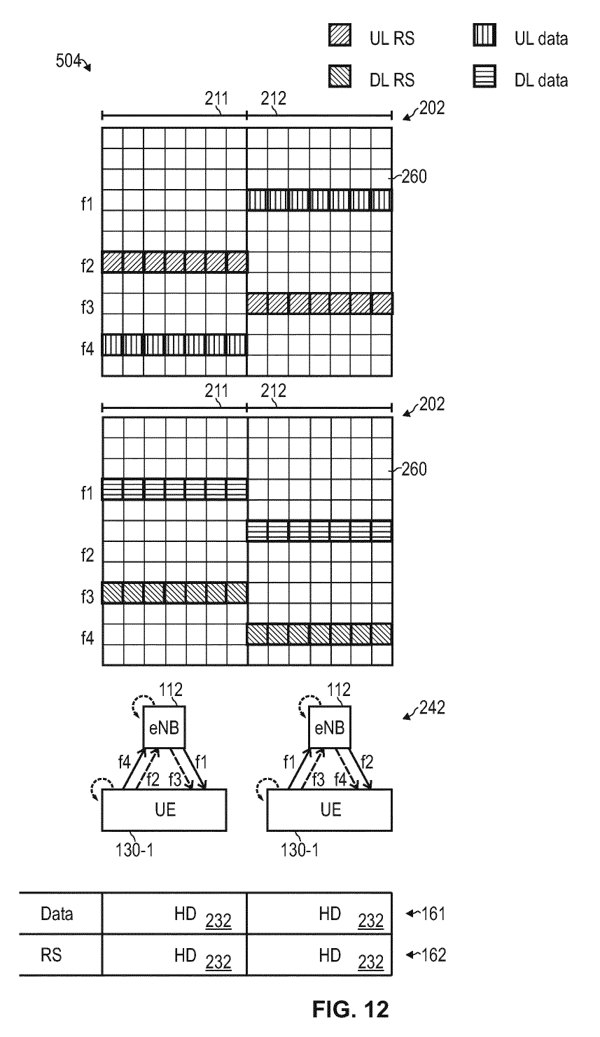

FIG. 9 illustrates aspects with respect to the resource mapping 501 (compare with FIG. 5) for a two-node scenario 242 (in FIG. 9, UL communication 202 is shown in the upper part while DL communication 201 is shown in the lower part). FIG. 10 illustrates aspects with respect to the resource mapping 502 (compare with FIG. 6) for a two-node scenario 242. FIG. 11 illustrates aspects with respect to the resource mapping 503 (compare with FIG. 7) for a two-node scenario 242. FIG. 12 illustrates aspects with respect to the resource mapping 504 (compare with FIG. 8) for a two-node scenario 242.

From a comparison of FIGS. 9-12 with FIGS. 5-8 it is apparent that corresponding techniques as described herein may be readily applied for two-node scenarios 242 and three-node scenarios 243.

The various resource mappings 501-504 as discussed above with respect to FIGS. 5-12 are examples only. In other examples, a different allocation of the resources 260 is conceivable. Further, different combinations of UL communication 202 and DL communication 201 are possible.

In some examples, the resource mappings 501-504 are predefined. Alternatively or additionally, it is also possible that at least some of the resource mappings 501-504 are configured on demand, e.g., by the eNB 112. E.g., at least some of the resource mappings 501-504 may be configured in a connected state while the data bearer 150 is established.

The various resource mappings 501-504 have been discussed above with respect to FIGS. 5-12 in the context of allocation of the resources 260. The various resource mappings 501-504 can also be associated with further properties of communication on the radio link 111. Such further properties of the communication include, e.g., the transmit power, multi-antenna pre-coding, beamforming properties, etc. E.g., the various resource mappings 501-504 may also be associated with a certain transmit power of data 161 and/or of reference signals 162.

As will be appreciated from the discussion of FIGS. 5-12, depending on the particular choice of the resource mapping 501-504, communication on the radio link 111 can be tailored for spectrum efficiency and/or transmission reliability. In the various examples described herein, communication according to the different resource mappings characterized with respect to FD 231 and/or HD 232 for UL data 161, DL data 161, UL reference signals 162, and DL reference signals 162, respectively, is accomplished.

In some examples, a particular resource mapping 501-504 may be selected and statically maintained, e.g., as long as the bearer 150 is active. In some examples, switching between different resource mappings 501-504 as a function of time may be performed. Thus, changing channel conditions can be taken into account by dynamically adjusting the duplex scheme.

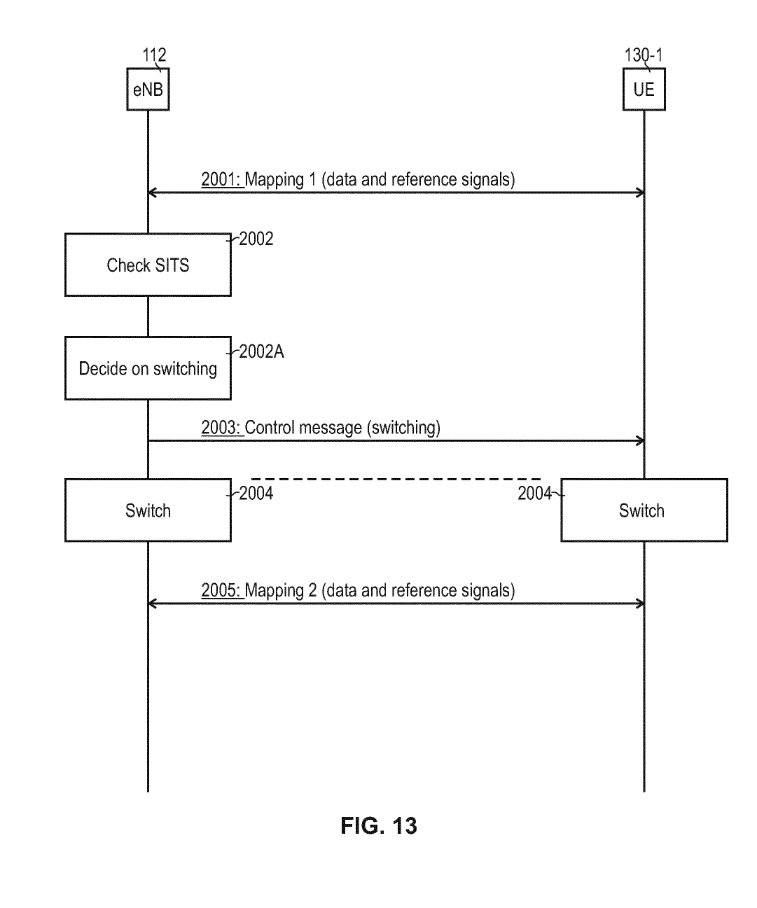

In FIG. 13, aspects relating to switching 2004 between different resource mappings 501-504 is illustrated in a signaling diagram for signaling via the radio link 111 between the eNB 112 and the terminal 130-1. Switching may be performed with respect to any two resource mappings 501-504 which are at least partially different from each other with respect to duplex communication, e.g., for data 161 and/or reference signals 162.

First, communication 2001 between the eNB 112 and the terminal 130-1, i.e., UL communication 202 and/or DL communication 201, is implemented according to a first resource mapping 501-504. The communication 2001 may comprise data 162 and reference signals 162. The communication 2001 of reference signals 162 may be used as a decision criterion for executing said switching between different resource mappings 501-504. E.g., a quality of reception of the resource signals 162 may be considered. E.g., corresponding measurement reports may be considered.

In detail, at a step 2002, the eNB 112 checks a ratio between self-interference 251 and a signal (Signal-Interference to-signal Ratio, SITS). The SITS may be determined based on reference signals 162 as part of communication 2001. In the example of FIG. 13, the SITS is used as a decision criterion for selectively executing said switching at step 2004. In other examples implementations, additional or alternative decision criteria for selectively executing said switching at step 2004 such as a path loss, a terminal-to-terminal interference 252, a capability of the terminal 130-1, 130-2 to suppress interference, a measured overall signal strength, etc. may be used. Some of these properties may be derived from communicating resource signals 162 during communication 2001.

Further, at a step 2002A, the eNB 112 decides, based on the SITS and/or other factors such as the path loss as indicated above, that switching should be executed. A corresponding control message 2003 is communicated between the eNB 112 and the terminal 130-1. The control message 2003 triggers said switching 2004. In response to receiving the control message 2003, the terminal 130-1 executes said switching at step 2004. Likewise, in response to transmitting the control message 2003, the eNB 112 executes said switching at step 2004. Hence, the execution of the switching at step 2004 is executed by the eNB 112 and the terminal 130-1 in a time-synchronized manner in based on communicating the control message 2003. In response to said switching at step 2004, communication 2005 is executed according to the different resource mapping 501-504.

In the example of FIG. 13, the decision logic for triggering said switching is situated at the eNB 112. As such, this implementation may be of particular relevance for a three-node communication scenario.

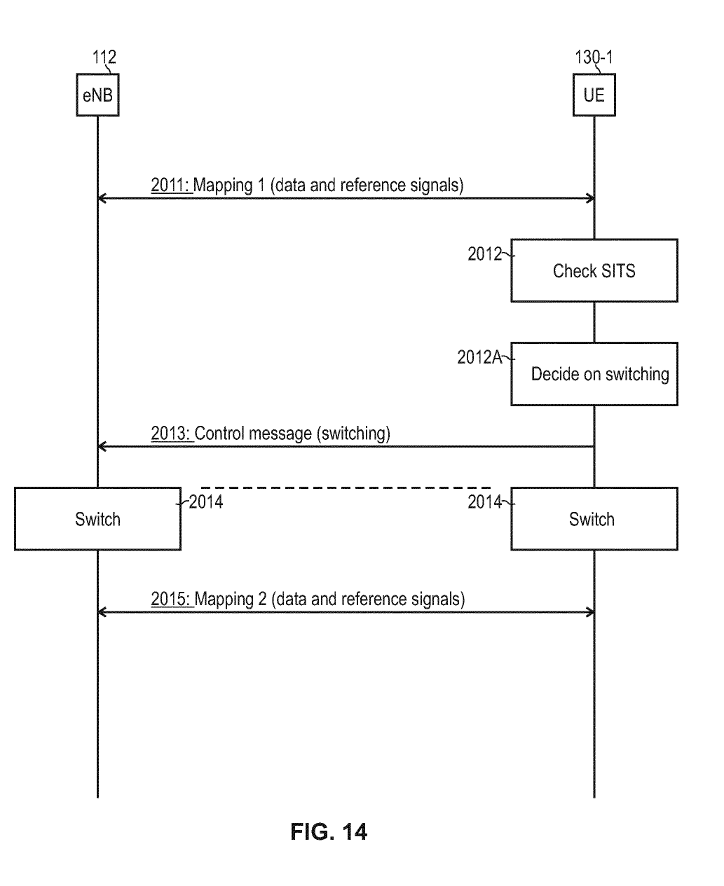

FIG. 14 illustrates further aspects with respect to switching at step 2014 between different resource mappings 501-504 in a signaling diagram showing signaling via the radio link 111 between the eNB 112 and the terminal 130-1. FIG. 14 generally corresponds to the scenario of FIG. 13. However, in the example of FIG. 14, the decision logic for triggering said switching is implemented at the terminal 130-1 and not at the eNB 112. As such, the scenario of FIG. 14 may particularly apply in a two-node communication scenario 242, e.g., a D2D communication scenario.

In detail, communication 2011 corresponds to communication 2001. Steps 2012, 2012A corresponds to steps 2002, 2002A, albeit executed at the terminal 130-1. The control message 2013 corresponds to the control message 2003; however, the control message 2003 is a DL control message, while the control message 2013 is an UL control message. Step 2014 corresponds to step 2004. 2015 corresponds to 2005.

In some scenarios, the different resource mappings 501-504 between which said switching at steps 2004, 2014 of FIGS. 13 and 14 is implemented may also be associated with a certain transmit power. In such a scenario, the control messages 2003, 2013 may also be indicative of the respective transmit power. Thereby, the transmit power of reference signals 162 can be set. E.g., power boosting of resource signals 162 may be implemented in such a manner, e.g. when the interference 251, 252 is comparably limited. In general, by using a higher transmit power, more accurate channel sensing may be employed.

FIGS. 13 and 14 illustrate examples with the decision logic for triggering said switching being implemented either at the eNB (compare with FIG. 13) or at the terminal 130-1 (compare with FIG. 14). However, also intermediate solutions are conceivable in which the decision logic is distributed between the eNB 112 and the terminal 130-1. In such an example, the execution of said switching may be negotiated between the eNB 112 and the terminal 130-1. In this regard, negotiating said switching can include communicating a plurality of control messages between the eNB 112 and the terminal 130-1. E.g., candidate points in time for executing said switching and/or candidate resource mappings 501-504 may be proposed and accepted/rejected. Negotiating may also include communicating recommendations for the particular resource mapping 501-504 which should be used.

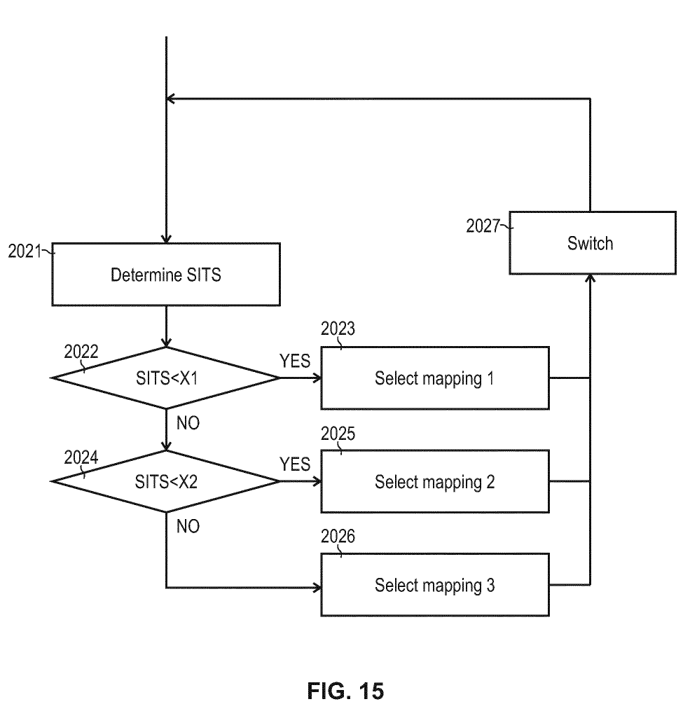

As indicated above, one particular decision criterion for selectively executing said switching is the SITS. FIG. 15 illustrates aspects relating to the decision logic for selectively executing said switching in greater detail. In this example, the SITS is considered in order to judge whether executing or not executing said switching.

First, at 2021, the SITS is determined, e.g. based on communicating reference signals 162 particularly according to one of the resource mappings 501-504.

Next, a first threshold comparison 2022 is executed. The first threshold comparison 2022 compares the SITS with a first threshold which is labeled X1. If the SITS is smaller than the first threshold, a first resource mapping 501-504 is selected, 2023. Switching is executed accordingly, 2027. The first threshold may be predefined and/or may specify a value in dB.

If the determination in the step 2022 is not in the affirmative, a second threshold comparison 2024 is executed. The second threshold comparison compares the SITS with a second threshold which is labeled X2. If the SITS is smaller than the second threshold, a second resource mapping 501-504 is selected, 2025. Switching is executed accordingly, 2027.

If, however, the SITS is larger than the second threshold, a third resource mapping 501-504 is selected, 2026. Switching is executed accordingly, 2027.

E.g., at 2023, the resource mapping 501 may be selected, since the SITS in this scenario may be comparably small. E.g., at 2025, the resource mapping 502 or the resource mapping 503 may be selected, since the SITS in the scenario may be moderate. E.g., at 2026, the resource mapping 504 may be selected, since the SITS in this scenario may be comparably large.

While in the example of FIG. 15, two threshold comparisons 2022, 2024 are shown, in other examples, a smaller or larger number of threshold comparisons may be executed.

After executing said switching at 2027, the step 2021 is executed anew. E.g., the step 2021 may be executed in fixed time intervals. It is also possible to consider certain trigger criterions for determining the SITS at 2021. As such, the SITS can be monitored, i.e., repeatedly checked.

While in the example of FIG. 15, the decision for switching between different resource mappings 501-504 is based on the SITS, in other examples, alternative or additional performance characteristics may be taken into account at 2012, 2022, 2024. In particular, it is possible to take into account a path loss of communication 201, 202 between the eNB 112 and the respective terminal 130-1, 130-2. E.g., the path loss may also be determined based on communication of reference signals 162.

Depending on the particular resource mapping 501-504, communication of reference signals 162 may suffer from interference. Even for scenarios employing HD 232 for communication of reference signals 162, depending on properties such as orthogonality between different resources 260, a distance in frequency space between the different resources 260, etc., significant residual interference 251, 252 can exist which degrades the communication of reference signals 162. In particular, residual interference 251, 252 from communication of data 161 may affect the accuracy of channel sensing based on communication of reference signals 162. Sometimes, it may be desirable to suppress such residual interference 251, 252. In such a scenario, a resource mapping may be employed which has no or only insignificant interference 251, 252 from communication of data 161 affecting the communication of reference signals 162.

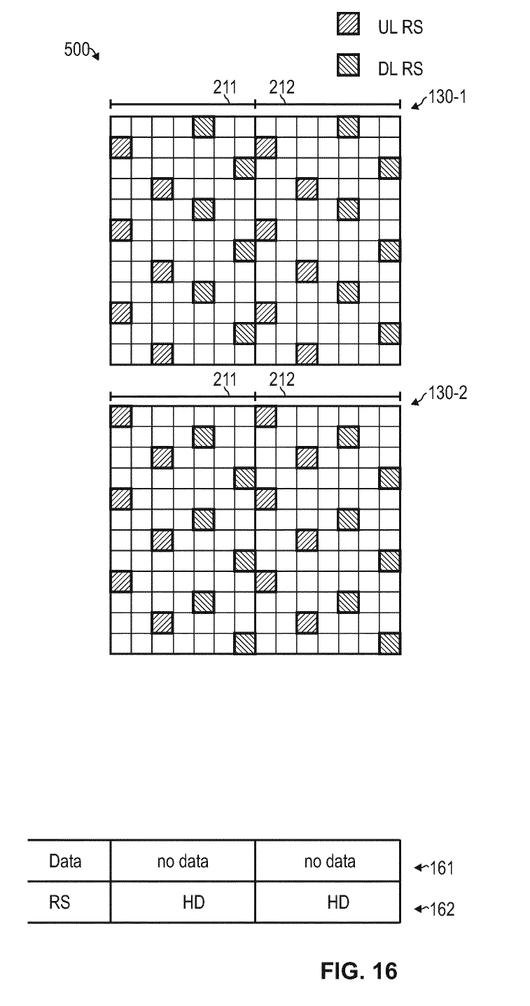

Such a scenario is illustrated in FIG. 16 showing aspects related to a further resource mapping 500 employing HD 232 of reference signals 162 only. In other words, communication of data 161 is not executed when the further resource mapping 500 is active, and the further resource mapping 500 does not allocate resources 260 for data.

In the example of FIG. 16, the further resource mapping 500 is illustrated for a three-node scenario 243. The resource mapping 500 can also be implemented for a two-node scenario 242. In general, channel sensing based on reference signals 162 communicated in accordance with the further resource mapping 500 can be executed at a high accuracy. In particular, interference 251, 252 from communication of data 161 is suppressed. As such, the further resource mapping 500 can be interpreted as a “clean” resource mapping, because a quality of communicating reference signals 162 is not degraded due to communication of data 161.

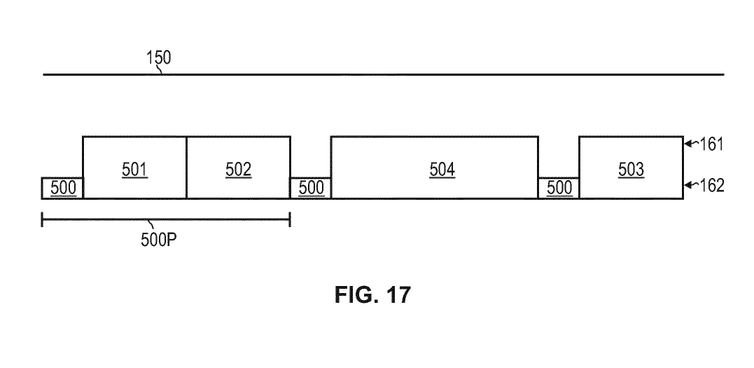

FIG. 17 illustrates aspects related to repeatedly switching to the further resource mapping 500 in a connected state while a data bearer 150 is established on the radio link 111. As can be seen from FIG. 17, the further resource mapping 500 is repeatedly activated with a certain periodicity 500P or according to non-periodic timing patterns or timing patterns comprising a plurality of periodicities. Because the further resource mapping 500 is repeatedly activated, the further resource mapping 500 may be interpreted as default resource mapping.

E.g., reference signals 162 communicated according to the further resource mapping 500 may be specific to one of the terminals 130-1, 130-2 and/or may be broadcasted to an indefinite set of terminals.

In between periods during which the further resource mapping 500 is active, communication according to the resource mappings 501-504 may be executed in order to transmit data 161. Switching between the resource mappings 501-504 may take place, e.g., as described above with respect to FIGS. 13-15.

By repeatedly switching to the further resource mapping 500, it is possible to execute channel sensing at a certain time resolution with a high accuracy.

In the example of FIG. 17, switching between the resource mappings 501-504, as well as to the further resource mapping 500 is executed in the connected state, wherein the data bearer 150 is established over the radio link 111. In some examples, switching to the further resource mapping 500 may be executed during an attach procedure of the terminal to the cellular network 100. Such an attach procedure may comprise a Random Access procedure and/or a Radio Resource Control (RRC) Connection setup procedure. The attach procedure may be executed after the respective terminal 130-1, 130-2 has been switched off and when powering on and/or after an out-of-coverage scenario. This may facilitate accurate channel sensing when setting up the data bearer 150 initially.

While in the scenario of FIG. 17 the further resource mapping 500 is repeatedly activated, in other scenarios a decision criterion may be considered which selectively triggers switching to the further resource mapping 500. One particular decision criterion for activating the further resource mapping 500 may be that recent measurement reports based on communication of reference signals 162 are not available to the eNB 112 and/or the respective terminal 130-1, 130-2. A further decision criterion may include that the respective terminal 130-1 and/or the eNB 112 assesses that the measurement reports available are obsolete or outdated, unreliable, or that the measurement accuracy is worse than a threshold. Such an example threshold may relate to the signal strength being outside +/−8 dB of range. In such a scenario, it can be checked whether the available measurement reports are obtained within a certain delay.

The switching between the various resource mappings 500, 501-504 may take place on different time scales. In some examples, said switching may be executed on a comparably short time scale, e.g. every couple of symbols, every couple of timeslots 211, 212, every couple of subframes, TTIs, or frames. E.g., it may be re-evaluated whether said switching is to be executed at least once every 10 seconds, or at least once every second, or at least once every 500 milliseconds, or at least once every 10 milliseconds, or at least once every millisecond, or at least once every 0.5 milliseconds. E.g., the timescale may be correlated with the frequency of received measurement reports and/or terminal scheduling. E.g., a frequency of re-evaluating whether said switching is to be executed may depend on a bandwidth of the bearer 150; e.g., a larger bandwidth of the bearer 150 may typically require a higher frequency of re-evaluating.

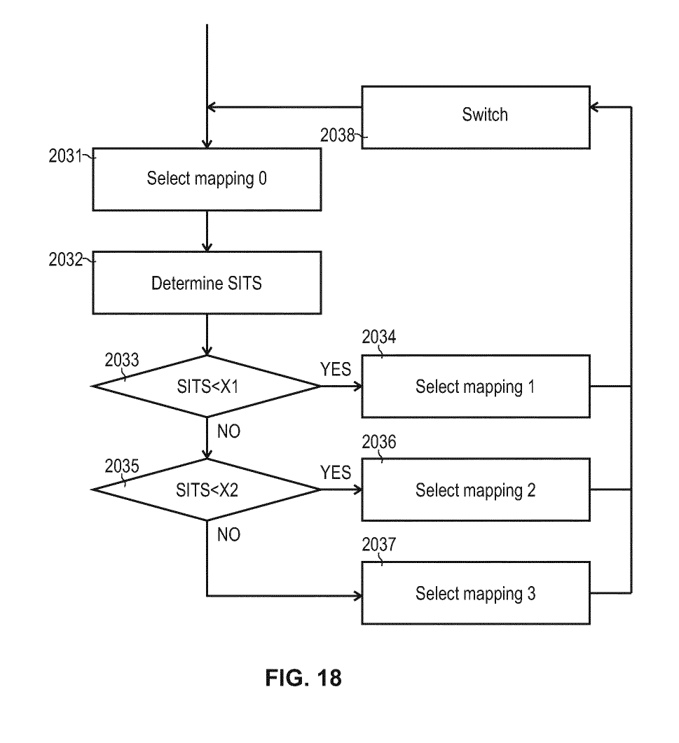

FIG. 18 illustrates aspects with respect to switching between the various resource mappings 500, 501-504. The scenario of FIG. 18 generally corresponds to the scenario of FIG. 15. However, in the example of FIG. 18, the further resource mapping 500 is repeatedly activated, 2031. The SITS is determined based on communicating of reference signals 162 in accordance with the further resource mapping 500, 2032. Thereby, the SITS can be determined at a high accuracy. 2033-2038 correspond to 2022-2027.

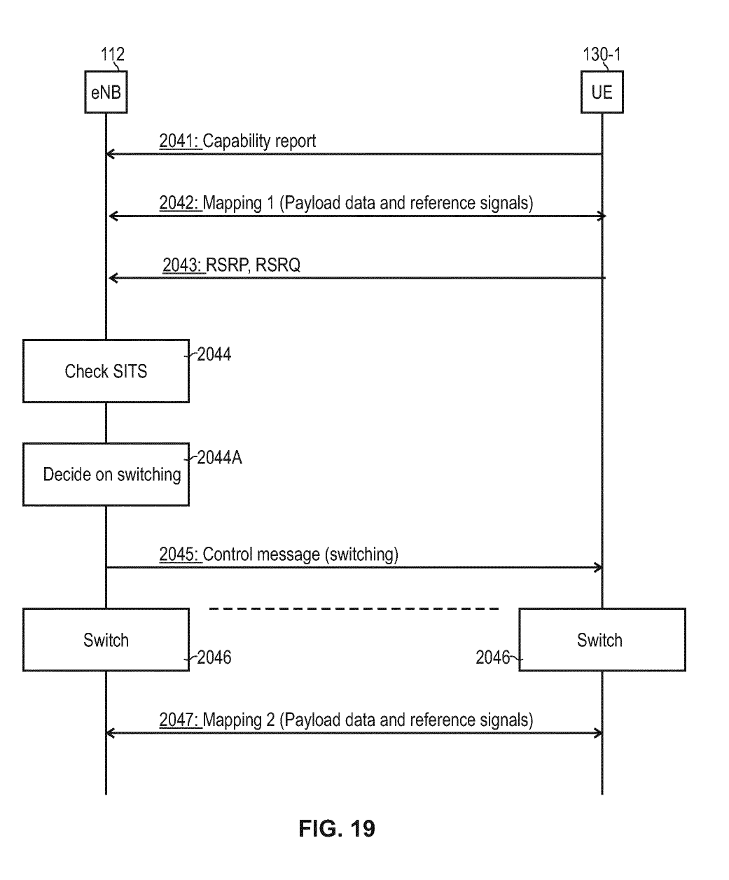

FIG. 19 illustrates aspects with respect to executing said switching. However, in the example of FIG. 19, said switching is executed depending on a measurement report 2043 communicated from the respective terminal 130-1, 130-2 to the eNB 112. The measurement report is indicative of a quality of communicating on the radio link 111. E.g., the measurement report may be determined based on communicating of reference signals, e.g., according to one of the resource mappings 500, 501-504. The measurement report 2043 may be established as part of channel sensing. In the example of FIG. 19, the measurement report 2043 may be a Reference Signal Received Quality (RSRQ) and/or a Reference Signal Received Power (RSRP). Other examples of measurement reports include the channel quality indicator (CQI), the rank indicator (RI), and the pre-coding matrix indicator (PMI). See, e.g., 3GPP, TS 36.214 Evolved Universal Terrestrial Radio Access (E-UTRA) Physical Layer Measurements”, V13.0.0, December 2015.

Said switching is also executed depending on a capability report 2041 communicated from the respective terminal 130-1, 130-2 to the eNB 112. The capability report 2041 may be indicative of a capability of the respective device 112, 130-1, 130-2 to execute said switching. E.g., in some scenarios, the capability report may indicate a FD and/or HD capability of the terminal 130-1. In further examples, the capability report 20041 may indicate a capability of changing between HD and FD according to dynamic switching as described herein. 2042 corresponds to 2001. 2044 corresponds to 2002. 2044A corresponds to 2002A. 2045 corresponds to 2003. 2046 corresponds to 2004. 2047 corresponds to 2005.

In the example of FIG. 19, the decision logic for triggering said switching 2046 resides at the eNB 112. In other examples, the decision logic can also, at least partly, reside at the terminal 130-1. In particular, when the decision logic resides at least partly at the terminal 130-1, said switching may be selectively executed depending on a measurement report communicated from the eNB 112 to the respective terminal 130-1, 130-2 (not shown in FIG. 19), and/or a capability report communicated from the eNB 112 to the respective terminal 130-1, 130-2 (not shown in FIG. 19).

While FIG. 19 illustrates a two-node communication scenario 242, respective techniques may be also applied in a three-node communication scenario 243. In such a scenario, the capability report and the measurement report may be received from both terminals 130-1, 130-2 participating in the three-node communication scenario 243 (not shown in FIG. 19).

Various examples have been illustrated above in which communication of reference signals 162 in accordance with a resource mapping 500, 501-504 is used for selectively executing said switching between different resource mappings 501-504. Communication of reference signals 162 can be used for a wide variety of applications, beyond said selectively executing of said switching. One particular application may relate to selecting pairs of terminals 130-1, 130-2 which qualify for a three-node communication scenario 243.

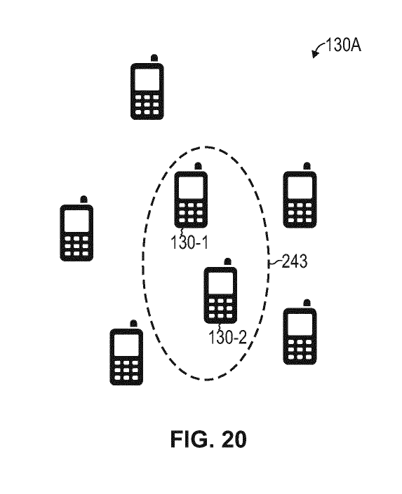

FIG. 20 illustrates aspects relating to selecting a first terminal 130-1 and the second terminal 130-2 from the plurality of candidate terminals 130A depending on said communicating of reference signals 162. E.g., reference signals 162 may be communicated in accordance with one of the resource mappings 500, 501-504. Based on said communicating of reference signals 162, channel sensing may be employed. Different performance characteristics of the channel sensing may be used when selecting the first and second terminals 130-1, 130-2 for the three-node communication scenario 243. Such performance characteristics may include the SITS and/or the path loss.

The first and second terminals 130-1, 130-2 may be selected for the three-node communication scenario 243 based on the further properties such as one or more elements selected from the group comprising an angle of arrival of reference signals 162, and a location of the first terminal 130-1 and the second terminal 130-2 with respect to the eNB 112.

By taking into account such decision criteria as described above when deciding which terminals 130-1, 130-2 should participate in the three-node communication scenario 243, a beneficial decision can be made which reduces or limits interference 251, 252. Here, the expected future interference 251, 252 may be estimated. The pair of terminals 130-1, 130-2 may be selected based on an expected minimum interference 251, 252.

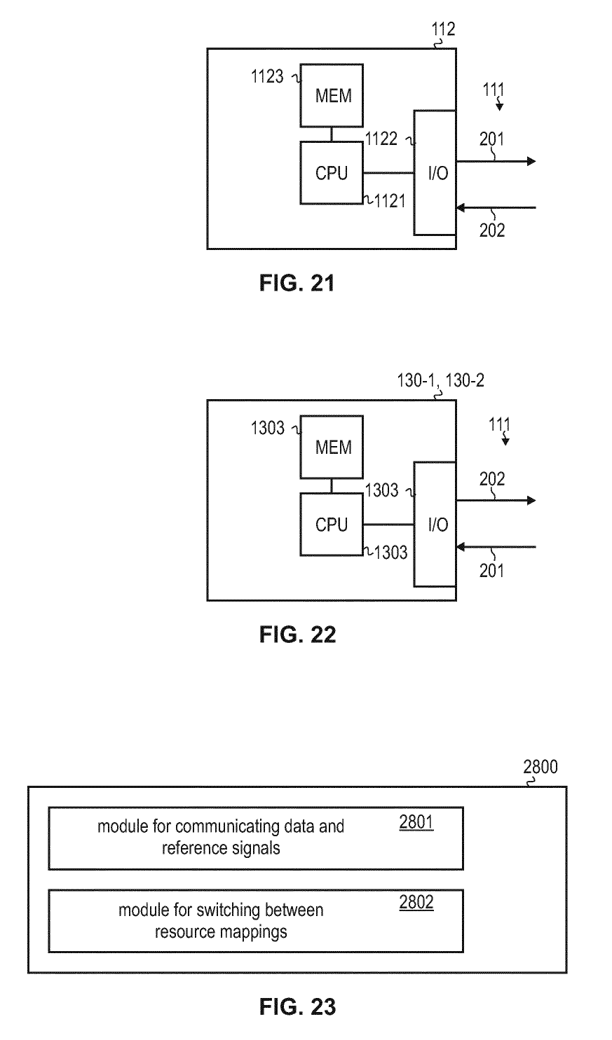

FIG. 21 schematically illustrates an access node according to various embodiments. For example, the access node may correspond to the above described eNB 112. The eNB 112 comprises a processor 1121 and a memory 1123, e.g., a non-volatile memory. The eNB 112 may further comprise an interface 1122. The interface 1122 is configured to perform DL communication 201 and UL communication 202 on the radio interface 111. The processor 1121 is configured to execute instructions stored in the memory 1123. Executing such instructions can cause the processor 1121 to perform techniques as described herein with respect to: communicating in accordance with at least one of the resource mappings 500, 501-504; switching between different resource mappings 500, 501-504; channel sensing; transmitting reference signals 162; receiving reference signals 162; transmitting measurement reports; receiving measurement reports; and/or participating in the decision for selectively executing said switching; etc.

The interface 1122 may be capable of performing FD 231 and/or HD 232.

FIG. 22 schematically illustrates a terminal according to various embodiments. For example, the terminal may be one of the above described terminals 130-1, 130-2. The terminal 130-1, 130-2 comprises a processor 1301 and a memory 1303, e.g., a non-volatile memory. The terminals 130-1, 130-2 may further comprise an interface 1302. The interface 1302 is configured to perform DL communication 201 and UL communication 202 on the radio interface 111. The processor 1301 is configured to execute instructions stored in the memory 1303. Executing such instructions can cause the processor 1301 to perform techniques as described herein with respect to: communicating in accordance with at least one of the resource mappings 500, 501-504; switching between different resource mappings 500, 501-504; channel sensing; transmitting reference signals 162; receiving reference signals 162; transmitting measurement reports; receiving measurement reports; and/or participating in the decision for selectively executing said switching; etc.

The interface 1302 may be capable of performing FD 231 and/or HD 232. In some embodiments, the terminal 130-1, 130-2 may be capable of performing FD 231, in others embodiments, the terminal 130-1, 130-2 is not capable of performing FD.

FIG. 23 schematically illustrates a device 2800. The device 2800 may be embodied as an access node, e.g. the above described eNB 112, and/or a terminal such as one of the above described terminals 130-1, 130-2. The device 2800 comprises a module 2801 for communicating data 161 and reference signals 162. The module 2801 can be configured to communicate according to one or more of the resource mappings 500, 501-504. The device 2800 further comprises a module 2802 for switching between the different resource mappings 500, 501-504. The device 2088 may be adapted to perform a method according to one or more embodiments described in the present disclosure. To this end, the various method steps may be performed by one or more of the modules 2801, 2802 or a respective additional module.

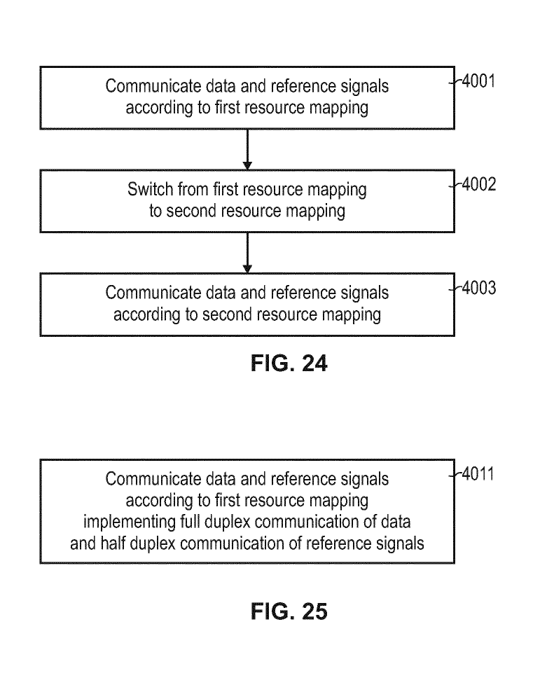

FIG. 24 is a flowchart of a method according to various embodiments. At 4001, data 161 and reference signals 162 are communicated according to a first resource mapping 501-504. The first resource mapping employs duplex communication 231, 232 of data 161 and reference signals 162, i.e., FD 231 and/or HD 232 of data 161, as well as FD 231 and/or HD 232 of reference signals 162. E.g., different duplex schemes may be employed for communication of data 161 and reference signals 162. Alternatively or additionally, different duplex schemes may be employed for UL communication 202 and DL communication 201.

At 4002, switching is executed between the first resource mapping 501-504 and a second resource mapping 501-504; the second resource mapping 501-504 is subsequently used for communication, 4003. The first and second resource mappings 501-504 may at least partly differ from each other, e.g., with respect to one or more of the following: duplex scheme for UL communication 202; duplex scheme for DL communication 201; duplex scheme for reference signals 162; duplex scheme for data 161; transmit power of reference signals 162; transmit power of data 162; etc.

The second resource mapping employs duplex communication 231, 232 of data 161 and reference signals 162, i.e., FD 231 and/or HD 232 of data 161, as well as FD 231 and/or HD 232 of reference signals 162. E.g., different duplex schemes may be employed for communication of data 161 and reference signals 162. Alternatively or additionally, different duplex strategies may be employed for UL communication 202 and DL communication 201.

FIG. 25 is a flowchart of a method according to various embodiments. At 4011, data 161 and reference signals 162 are communicated according to a first resource mapping 501-504. The first resource mapping 501-504 implements FD 231 of data 161 and HD 232 of reference signals 162.

The methods of FIGS. 24 and 25 may be executed by one or more of the terminals 130-1, 130-2 and/or the eNB 112.

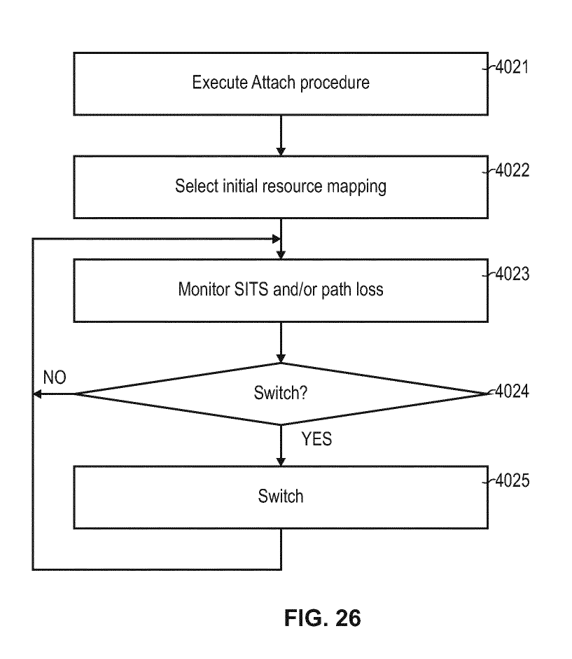

FIG. 26 is a flowchart of a method according to various embodiments. First, at 4021, the attach procedure is executed for a respective at least one terminal 130-1, 130-2. E.g., the attach procedure may be executed in response to power on or after an out-of-range scenario.

Then, at 4022, initial mode selection is executed. Here, the initial resource mapping 500, 501-504 is selected. In some examples, 4022 is performed by the eNB 112. As such, the decision logic for selecting the initial resource mapping 500, 501-504 may reside at the eNB 112.

Different decision criteria for selecting the initial resource mapping 500, 501-504 may be taken into account at least one of the following:

In one option, the at least one terminal 130-1, 130-2, continuously or on a regular basis, may report measurement results, e.g., signal strength, signal quality, signal-to-interference and noise (SINR), and/or block error rate (BLER) to the respective serving eNBs 112. Such measurement reports can serve the purpose of, e.g., mobility management or power control and can be done on a short timescale, such as several tens/hundreds of milliseconds. These measurement reports may also be taken into account as a decision criterion for selecting the initial resource mapping 500, 501-504.

In a second option, the eNB 112 may collect such measurement reports and may measure on UL reference signals 162, e.g., SRS, the estimated path loss and the UL received signal power that the eNB 112 can expect from the at least one terminal 130-1, 130-2. These measurements enable the eNB 112 to estimate the expected SITS experienced at the eNB 112. E.g., if a given terminal 130-1, 130-2 is at the cell edge, the expected received UL signal power can be low and the SITS at the eNB 112 in the case of FD 231 can be unacceptably high.

In a third option, the eNB 112 can trigger the at least one terminal 130-1, 130-2 to transmit, to the eNB 112, additional capability reports. The capability reports may relate to the capability of the at least one terminal 130-1, 130-2 in terms of UL reference signal power boosting, transmission bandwidth, terminal beamforming capability, and/or terminal receiver capability, etc. Alternatively or additionally, the capability reports may relate to capability of the at least one terminal 130-1, 130-2 to participate in FD 231 and/or participate in dynamic switching between different resource mappings 500, 501-504. In some examples, the at least one terminal 130-1, 130-2 may also autonomously transmit such capability reports to the eNB 112, e.g., during the start of the session/during the attach procedure. Information included in the capability report may, generally, enable the eNB 112 to determine whether a respective terminal 130-1, 130-2 is eligible for FD 231 and/or whether the respective terminal 130-1, 130-2 is capable of transmitting the UL reference signals 162 with a higher transmit power and/or with different pre-coding if compared to data 161.

Then, at 4026, the eNB 112 may use thresholds to determine which initial resource mapping 500, 501-504 is desirable. Here, the determined SITS and/or path loss may be compared with one or more thresholds. Alternatively or additionally, the eNB 112 may also consider an amount of data 161 to be communicated when selecting between different resource mappings 500, 501-504. In particular, different resource mappings 500, 501-504 may offer different bandwidth for communication of data 161.

In the example discussed above, the initial selection at 4022 is performed by the eNB 112. However, in various examples, the initial selection of the appropriate resource mapping 500, 501-504 may also be performed, at least partially, by the at least one terminal 130-1, 130-2. In such a case, the at least one terminal 130-1, 130-2 may select one of the resource mappings 500, 501-504 based on one or more criteria and may transmit the information about the selected resource mapping 500, 501-504 as a control message to the eNB 112. The at least one terminal 130-1, 130-2 may use corresponding or similar criteria as used by the eNB 112 and as discussed above; e.g., such criteria may include terminal radio measurement results, terminal capability, etc. In one exemplary implementation, the eNB 112 may select the initial resource mapping 500, 501-504 based on the indication our recommendation received from the at least one terminal 130-1, 130-2: Negotiation of the initial resource mapping 500, 501-504 is conceivable. E.g., the eNB 112 may determine a candidate initial resource mapping 500, 501-504 by itself/autonomously based on one or more criteria as discussed above; here, the eNB 112 may select the initial resource mapping 500, 501-504 based on the autonomously determined candidate resource mapping 500, 501-504 and the candidate resource mapping 500, 501-504 indicated by the at least one terminal 130-1, 130-2 in a respective control message. E.g., if the candidate resource mapping 500, 501-504 determined by the eNB 112 differs from the candidate resource mapping recommended by the at least one terminal 130-1, 130-2, then the eNB 112 may finally select the resource mapping 500, 501-504 which leads to the best signal quality and/or least interference 251, 252 for communication of reference signals 162. As can be seen, various examples exist of negotiating, between the eNB 112 and the at least one terminal 130-1, 130-2, the initial resource mapping 500, 501-504.

After performing the selection of the initial resource mapping 500, 501-504, the eNB 112, firstly, adapts reception and/or transmission, i.e., communication, of reference signals 162 and/or data 161 according to the selected resource mapping 500, 501-504; and, secondly, informs the at least one terminal 130-1, 130-2 about the selected initial resource mapping 500, 501-504 in order to enable the at least one terminal 130-1, 130-2 to transmit and/or receive data 161 and/or reference signals 162 according to the selected initial resource mapping 500, 501-504.

Then, at 4023, the SITS and/or the packet loss are monitored.

Based on the monitored SITS and/or path loss, at 2024 a decision is taken whether switching to a different resource mapping 500, 501-504 should be executed. Here, at least one of the following measures may be applied:

In a first option, again, one or more threshold comparisons can be executed where the SITS and/or the path loss is compared with a respective threshold or respective thresholds.

In a second option, signal measurements, such as CSI, e.g., CQI, as reported by the at least one terminal 130-1, 130-2 may be taken into account in the decision. E.g., a CSI, e.g., CQI, report that is over a predefined threshold may indirectly indicate that the available CSI available at the eNB 112 is of a sufficient quality. Thereby, the eNB 112 can judge that a resource mapping 501-504 implementing FD 231 may be reasonably selected.

In a third option, explicit recommendations from the at least one terminal 130-1, 130-2 may be taken into account. E.g., a scenarios conceivable where the at least one terminal 130-1, 130-2 experiences a low received signal strength. This may be, e.g., in conjunction with radio measurements such as RSRP, RSRQ, SINR, RSSI, CSI-RSRP, etc. In such a scenario, the at least one terminal 130-1, 130-2 may transmit a corresponding control message indicating a preference to avoid FD 231.

In a fourth option, power headroom reporting from the at least one terminal 130-1, 130-2 may be taken into account. The eNB 112 may use power headroom reports received from the at least one terminal 130-1, 130-2 to determine if a FD 231 can be an option for, e.g., communication of reference signals 162. E.g., a power headroom which is lower than a predefined threshold may indicate that the received signal strength of reference signals 162 at the eNB 112 is low; consequently, such reference signals 162 may be especially susceptible to self-interference 251. Therefore, under certain power headroom threshold, the eNB 112 may decide to use HD 231 for reference signals 162; a corresponding resource mapping 500, 502-504 may be selected.

In the example illustrated above, the decision logic for deciding on whether to execute said switching at 4024 is located at the eNB 112. However, corresponding to said logic may also recite, at least partially, at the at least one terminal 130-1, 130-2. In such a scenario, the at least one terminal 130-1, 130-2 may decide to switch the current resource mapping 500, 501-504 based on one or more criteria and may transmit corresponding information about the newly applicable resource mapping 500, 501-504 to the eNB 112. The at least one terminal 130-1, 130-2 may use corresponding or similar criteria as used by the eNB 112 and as discussed above, e.g., terminal radio measurement results, etc. In one example, the eNB 112 may switch based on the indication of a recommendation of a candidate resource mapping 500, 501-504 received from the at least one terminal 130-1, 130-2. In a further example, the eNB 112 may also autonomously determine if the current resource mapping 500, 501-504 is required to be switched based on one or more criteria as outlined above; judging whether switching is actually executed may then be based on the candidate resource mapping 500, 501-504 autonomously determined by the eNB 112, as well as on the candidate resource mapping indicated by the at least one terminal 130-1, 130-2. E.g., if the candidate resource mapping 500, 501-504 determined autonomously by the eNB 112 differs from the candidate resource mapping 500, 501-504 recommended by the at least one terminal 130-1, 130-2, then the eNB 112 may ultimately switch to the particular resource mapping 500, 501-504 which leads to the best signal quality and/or least interference 251, 252 for reference signals 162. In a further example, the eNB 112 may only switch to a different resource mapping 500, 501-504, if the candidate resource mapping 500, 501-504 determined by the eNB 112 is the same as the candidate resource mapping 500, 501-504 determined by the at least one terminal 130-1, 130-2. As can be seen, various examples exist of negotiating, between the eNB 112 and the at least one terminal 130-1, 130-2 whether said switching is to be executed.

If, at 4024, it is determined that switching is to be executed, switching is executed at 4025. Otherwise, 4023 is executed anew.

Summarizing, above, techniques have been illustrated which enable to dynamically switch between different resource mappings employing duplex communication. Thereby, in particular, different resource mappings for communicating reference signals and/or data can be implemented. The different resource mappings may show different characteristics regarding interference, because different duplex schemes may be implemented.

By tailoring the expected interference, different strategies for channel sensing can be employed. In particular, the trade-off situation between bandwidth occupation by reference signals used for channel sensing, on the one hand side, and disturbance of reference signals by interference can be tailored. An active management of channel sensing can be implemented.

Above, techniques have been illustrated which enable to select between FD and HD dynamically and separately for data and reference signals. Thereby, efficient management of the above-identified trade-off situation between overhead due to communication of reference signals and quality of reference signal communication can be achieved.

To sum up, by the techniques disclosed herein, improvement of the spectral efficiency and the achievable user bit rates when employing duplex communication can be accomplished.

Above, techniques have been outlined which enable application of full-duplex and/or half duplex transmission for reference signals and/or data. Within the corresponding resource mappings high quality CSI can be acquired, and, at the same time, the resources required for acquiring such high-quality CSI can be minimized.

The techniques are based on the finding that within a certain level of self-interference suppression capability, the quality of reference signals can be sufficiently good in full-duplex mode, but that there may also be some scenarios where an undisturbed, clean reception of reference signals is needed. By dynamically switching between different resource mappings, such a dynamic tailoring of the interference level to which communication of reference signals is exposed may be achieved.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

1-30. (canceled)

31. A method, comprising:
communicating data and reference signals with at least one device on a radio link according to a first resource mapping;
switching from the first resource mapping to a second resource mapping;
in response to the switching, communicating data and reference signals with the at least one device on the radio link according to the second resource mapping;
wherein the first resource mapping and the second resource mapping implement duplex communication of data and of reference signals.

32. The method of claim 31, wherein the first resource mapping implements full duplex communication of data and half duplex communication of reference signals.

33. The method of claim 31, wherein the second resource mapping implements full duplex communication of data and full duplex communication of reference signals.

34. The method of claim 31, wherein the second resource mapping implements half duplex communication of data and half duplex communication of reference signals.

35. A method, comprising:
communicating data and reference signals with at least one device on a radio link according to a first resource mapping;
wherein the first resource mapping implements full duplex communication of data and half duplex communication of reference signals.

36. The method of claim 35, further comprising:
switching from the first resource mapping to a second resource mapping;
in response to the switching, communicating data and reference signals with the at least one device on the radio link according to the second resource mapping;
wherein the second resource mapping implements full duplex communication of data and full duplex communication of reference signals.

37. The method of claim 35, further comprising:
switching from the first resource mapping to a second resource mapping;
in response to the switching: communicating data and reference signals with the at least one device according to the second resource mapping;
wherein the second resource mapping implements half duplex communication of data and half duplex communication of reference signals.

38. The method of claim 31, wherein the switching is selectively executed depending on the communicating of reference signals.

39. The method of claim 38, further comprising:
depending on the communicating of reference signals, monitoring at least one of a self-interference level and a path loss;
wherein the switching is selectively executed depending on the at least one of the monitored self-interference level or the monitored path loss.

40. The method of claim 39, further comprising:
executing a threshold comparison of the at least one of the monitored self-interference level and the monitored path loss versus at least one threshold;
wherein the switching is selectively executed depending on a result of the executed threshold comparison.

41. The method of claim 31, wherein the switching is executed in a connected state while a bearer associated with the at least one device is established on the radio link.

42. The method of claim 31, further comprising negotiating execution of the switching with the at least one device.

43. The method of claim 31, further comprising communicating a control message with the at least one device on the radio link, the control message triggering the switching.

44. The method of claim 31, wherein:
the first resource mapping implements full duplex communication of uplink reference signals and implements half duplex communication of downlink reference signals; or
the first resource mapping implements full duplex communication of downlink reference signals and implements half duplex communication of uplink reference signals.

45. The method of claim 31, wherein:
the first resource mapping implements full duplex communication of uplink data and implements half duplex communication of downlink data; or
the first resource mapping implements full duplex communication of downlink data and implements half duplex communication of uplink data.

46. The method of claim 31, further comprising:
setting a transmit power of reference signals communicated according to the first resource mapping;
communicating a control message with the at least one device on the radio link, the control message being indicative of the transmit power.

47. The method of claim 31, further comprising:
communicating reference signals with the at least one device on the radio link according to a further resource mapping;
wherein the further resource mapping does not allocate resources for data.

48. The method of claim 47, further comprising repeatedly switching to the further resource mapping in a connected state while a data bearer associated with the at least one device is established on the radio link.

49. The method of claim 47, further comprising switching to the further resource mapping during an attach procedure of a terminal to a cellular network.

50. A device, comprising:
processing circuitry;
memory containing instructions executable by the processing circuitry whereby the device is operative to:
communicate data and reference signals with at least one further device on a radio link according to a first resource mapping;
switch from the first resource mapping to a second resource mapping;
in response to the switching, communicate data and reference signals with the at least one further device on the radio link according to the second resource mapping;
wherein the first resource mapping and the second resource mapping implement duplex communication of data and of reference signals.

51. A device, comprising:
processing circuitry;
memory containing instructions executable by the processing circuitry whereby the device is operative to:
communicate data and reference signals with at least one further device on a radio link according to a first resource mapping;
wherein the first resource mapping implements full duplex communication of data and half duplex communication of reference signals.
